(19) United States
(12) Patent Application Publication
(10) Pub. No.: US 2025/0343996 A1
(43) Pub. Date: Nov. 6, 2025

(54) DEFECTIVE PIXEL ENCODING FOR CAMERA PROCESSING

(71) Applicant: QUALCOMM Incorporated, San Diego, CA (US)

(72) Inventors: David Berman, San Diego, CA (US); Weiliang Liu, San Diego, CA (US)

(21) Appl. No.: 18/652,355

(22) Filed: May 1, 2024

(51) Int. Cl. H04N 23/81

(52) U.S. Cl. CPC H04N 23/81

(57) ABSTRACT

An image sensor may be configured to output digital values for each pixel of the image sensor, where the digital values indicate a light intensity. Such digital values may range from 0 to 2ⁿ−1, where n represents the number of bits used to represent each value. To indicate which pixels of the image sensor are defective pixels, the image sensor may encode the pixel data such that one or more digital values indicate a defective pixel or type of defective pixels. The remaining digital values in the range represent the light intensity. An image signal processor may receive the encoded pixel data and determine which of the pixels are defective pixels directly from the encoded pixel data. The image signal processor may then perform a defective pixel correction process on the identified defective pixels.

### TECHNICAL FIELD

The disclosure relates to image processing.

### BACKGROUND

A camera device includes one or more cameras that capture stand-alone images or video frame sequences. Examples of a camera device include stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, gaming devices, computer devices that include cameras, such as so-called “web-cams,” smartwatches, devices equipped with their own cameras, devices configured to control other devices equipped with cameras, or any devices with digital imaging or video capabilities.

A camera device processes the captured images and outputs the images for display. In some examples, the camera device controls the exposure, focus, and white balance to capture high quality images. In some examples, one or more pixels output by an image sensor of the camera device may be defective. An image signal processor of the camera device may be configured to perform a defective pixel correction process on defective pixels.

### SUMMARY

In general, this disclosure describes techniques for camera processing, including techniques for encoding information that indicates which pixels in an image sensor are defective pixels. An image sensor may be configured to output digital values for each pixel of the image sensor, where the digital values may indicate a light intensity. Such digital values may range from 0 to 2ⁿ−1, where n represents the number of binary bits used to represent each digital value. To indicate which pixels of the image sensor are defective pixels, the image sensor may encode the pixel output data such that one or more output digital values (e.g., values 0 and 1) indicate a defective pixel or a type of defective pixel. The remaining output digital values (e.g., 2 to 2ⁿ−1) in the range represent the light intensity.

An image signal processor may receive the encoded pixel data and determine which of the pixels are defective pixels directly from the encoded pixel data. The image signal processor may then perform a defective pixel correction process on the identified defective pixels. By encoding defective pixel information directly within the pixel output data values, the techniques of this disclosure may save memory, power, and complexity rather than other techniques that may use maps indicating the locations and types of defective pixels.

In one example, this disclosure describes an apparatus for processing pixel data output from a sensor, the apparatus comprising a memory configured to receive the pixel data, and one or more processors in communication with the memory, the one or more processors configured to receive the pixel data, wherein each pixel value of the pixel data is represented by a digital value in a range from 0 to 2ⁿ−1, wherein n is a number bits of the digital value, wherein one or more digital values in the range from 0 to 2ⁿ−1 indicate a type of defective pixel, and wherein remaining values in the range from 0 to 2ⁿ−1 indicate a light intensity value, determine whether a particular pixel is defective based on the encoded digital value of the particular pixel, and perform a defective pixel correction process on the particular pixel based on the particular pixel being determined to be defective.

In another example, this disclosure describes a method of processing pixel data from a sensor, the method comprising receiving pixel data, wherein each pixel value of the pixel data is represented by a digital value in a range from 0 to 2ⁿ−1, wherein n is a number bits of the digital value, wherein one or more digital values in the range from 0 to 2ⁿ−1 indicate a type of defective pixel, and wherein remaining values in the range from 0 to 2ⁿ−1 indicate a light intensity value, determining whether a particular pixel is defective based on the encoded digital value of the particular pixel, and performing a defective pixel correction process on the particular pixel based on the particular pixel being determined to be defective.

In another example, this disclosure describes an apparatus for processing pixel data, the apparatus comprising a sensor configured to capture pixel data, wherein each pixel value of the pixel data is represented by an original digital value in a range from 0 to 2ⁿ−1, and wherein the original digital value indicates a light intensity value, and processing circuitry in communication with the sensor, the processing circuitry configured to receive the pixel data, identify one or more pixels in the pixel data as being defective pixels, encode the pixel data to form encoded pixel data that identifies the defective pixels, wherein one or more digital values of the encoded pixel data in the range from 0 to 2ⁿ−1 indicate a type of defective pixel, and wherein remaining values of the encoded pixel data in the range from 0 to 2ⁿ−1 indicate a light intensity value, and send the encoded pixel data to an image signal processor.

In another example, this disclosure describes an apparatus for processing pixel data, the apparatus comprising a sensor configured to capture pixel data, wherein each pixel value of the pixel data is represented by an original digital value in a range from 0 to 2ⁿ−1, and wherein the original digital value indicates a light intensity value, and processing circuitry in communication with the sensor, the processing circuitry configured to receive the pixel data, determine one or more pixels as being defective pixels from a defective pixel location map stored in memory, encode the pixel data to form encoded pixel data that identifies the defective pixels, wherein one or more digital values of the encoded pixel data in the range from 0 to 2ⁿ−1 indicate a type of defective pixel, and wherein remaining values of the encoded pixel data in the range from 0 to 2ⁿ−1 indicate a light intensity value, and send the encoded pixel data to an image signal processor.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2 is a conceptual diagram illustrating one example of direct digital conversion of an image sensor output.

FIG. 3 is a conceptual diagram illustrating one example of an encoded digital conversion of an image sensor output in order to identify defective pixels.

FIG. 4 is a conceptual diagram illustrating another example of an encoded digital conversion of an image sensor output in order to identify defective pixels.

FIG. 5 is a block diagram illustrating one example of an encoded digital conversion of an image sensor output in order to identify defective pixels.

FIG. 6 is a flowchart illustrating one example process of the disclosure.

FIG. 7 is a flowchart illustrating another example process of the disclosure.

### DETAILED DESCRIPTION

Digital imaging sensors often exhibit pixel defects of individual pixels due to manufacturing variations. These defects may arise from environmental contamination during the semiconductor fabrication process, electrical inconsistencies in the layers of a sensor, or imperfections in micro-lenses. Although most sensors contain some defective pixels, the sensors are typically usable if the number and density of these defects are minimal (e.g., below a threshold amount). To enhance image quality, image processing systems invest considerable effort in detecting and correcting these defects.

Defective pixels are generally managed at two stages: within the imaging sensor itself or later during the digital image processing. Initially, defects are identified through post-fabrication testing, but before the sensor is shipped. The locations of the defects, which may be random and unique to each sensor die, are then recorded in static memory on the sensor. This information facilitates on-sensor correction during image acquisition, using dedicated circuitry to substitute data from one or more neighboring functional pixels for the defective ones.

However, not all imaging sensors come equipped with on-sensor correction capabilities. In this case, image signal processors (ISPs) may handle defective pixels by detecting and correcting the defective pixels as image data is received. This process, which often runs continuously for every frame processed, requires substantial memory and computational resources and can significantly increase power consumption. Moreover, while ISPs are adept at identifying common defect types like “hot” or “cold” pixels, more complex defects like “stuck” pixels pose greater challenges.

To streamline defective pixel management, a hybrid approach can be employed, combining defect location data from the sensor manufacturer with the corrective capabilities of ISPs. This strategy relies on the transfer and utilization of defect data, which can be achieved through various means. For instance, transmitting a location table once might save bandwidth, but would consume extensive ISP memory. Conversely, dynamically fetching portions of the table based on processing needs reduces memory demand, but increases the complexity of control circuitry, memory bandwidth, and power usage. As such, hybrid approaches may also exhibit drawbacks in terms of complexity, power, and memory bandwidth.

This disclosure describes techniques that may improve the efficiency of identifying defective pixels and their ultimate correction using defective pixel correction techniques. In particular, this disclosure describes techniques for the encoding of defect information directly into the pixel data. The encoding techniques presented herein can be achieved with low overhead in power, bandwidth, and memory requirements with minimal to no loss in image quality.

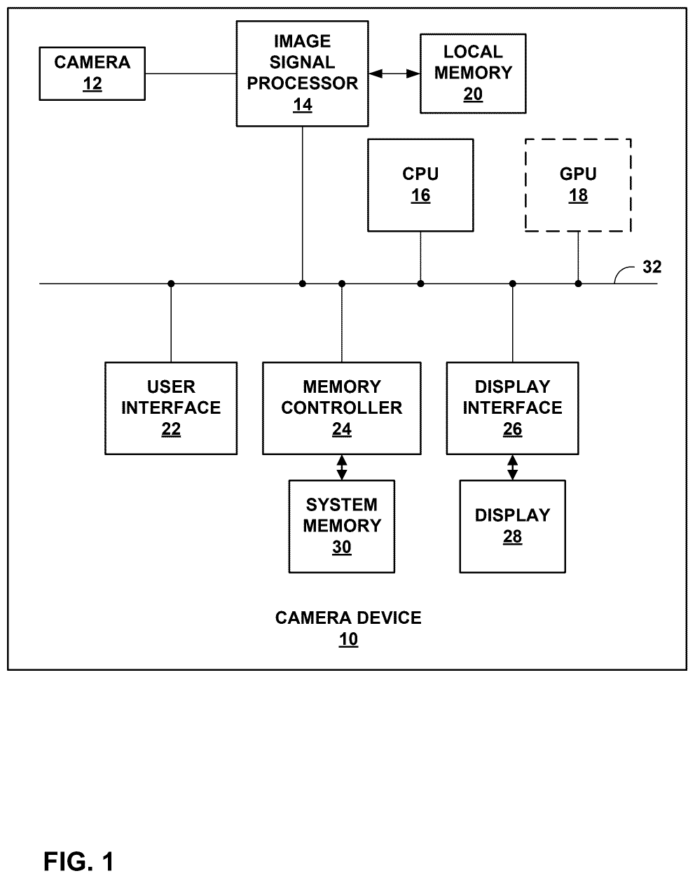

FIG. 1 is a block diagram of a device configured to perform one or more of the example techniques described in this disclosure for encoding the output of an image sensor to identify defective pixels. Examples of camera device 10 include stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, watches, gaming devices, computer devices that include cameras, such as so-called “web-cams,” or any device with digital imaging or video capabilities.

As illustrated in the example of FIG. 1, camera device 10 includes camera 12 (e.g., having an image sensor and lens), image signal processor 14 and local memory 20 of image signal processor 14, a central processing unit (CPU) 16, a graphical processing unit (GPU) 18 (optional), user interface 22, memory controller 24 that provides access to system memory 30, and display interface 26 that outputs signals that cause graphical data to be displayed on display 28. Although the example of FIG. 1 illustrates camera device 10 including one camera 12, in some examples, camera device 10 may include a plurality of cameras.

Also, although the various components are illustrated as separate components, in some examples the components may be combined to form a system on chip (SoC). As an example, image signal processor 14, CPU 16, GPU 18, local memory 20, and display interface 26 may be formed on a common integrated circuit (IC) chip. In some examples, one or more of image signal processor 14, CPU 16, GPU 18, and display interface 26 may be in separate IC chips. Additional examples of components that may be configured to perform the example techniques include a digital signal processor (DSP), a vector processor, or other hardware blocks used for neural network (NN) computations. Various other permutations and combinations are possible, and the techniques should not be considered limited to the example illustrated in FIG. 1.

The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry. Examples of local memory 20 and system memory 30 include one or more volatile or non-volatile memories or storage devices, such as random access memory (RAM), static RAM (SRAM), dynamic RAM (DRAM), erasable programmable ROM (EPROM), electrically erasable programmable ROM (EEPROM), flash memory, a magnetic data media or an optical storage media.

The various units illustrated in FIG. 1 communicate with each other using bus 32. Bus 32 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. The specific configuration of buses and communication interfaces between the different components shown in FIG. 1 is merely exemplary, and other configurations of camera devices and/or other image processing systems with the same or different components may be used to implement the techniques of this disclosure.

Memory controller 24 facilitates the transfer of data going into and out of system memory 30. For example, memory controller 24 may receive memory read and write commands, and service such commands with respect to memory 30 in order to provide memory services for the components in camera device 10. Memory controller 24 is communicatively coupled to system memory 30. Although memory controller 24 is illustrated in the example of camera device 10 of FIG. 1 as being a processing circuit that is separate from both CPU 16 and system memory 30, in other examples, some or all of the functionality of memory controller 24 may be implemented on one or both of CPU 16 and system memory 30.

System memory 30 may store program modules and/or instructions and/or data that are accessible by image signal processor 14, CPU 16, and GPU 18. For example, system memory 30 may store user applications (e.g., instructions for the camera application), resulting frames from image signal processor 14, etc. System memory 30 may additionally store information for use by and/or generated by other components of camera device 10. For example, system memory 30 may act as a device memory for image signal processor 14.

Image signal processor 14 is configured to receive image frames (or simply “images”) from camera 12, and process the images to generate output images for display. CPU 16, GPU 18, image signal processor 14, or some other circuitry may be configured to process the output images that include image content generated by image signal processor 14 into images for display on display 28. In some examples, GPU 18 may be further configured to render graphics content on display 28.

In some examples, image signal processor 14 may be configured as one or more image processing pipelines. Image signal processor 14 may include a camera interface that interfaces between camera 12 and image signal processor 14. Image signal processor 14 may include additional circuitry to process the image content. Image signal processor 14 outputs the resulting images with image content (e.g., pixel values for each of the image pixels) to system memory 30 via memory controller 24.

CPU 16 may comprise a general-purpose or a special-purpose processor that controls operation of camera device 10. A user may provide input to camera device 10 to cause CPU 16 to execute one or more software applications. The software applications that execute on CPU 16 may include, for example, a media player application, a video game application, a graphical user interface application or another program. The user may provide input to camera device 10 via one or more input devices (not shown) such as a keyboard, a mouse, a microphone, a touch pad or another input device that is coupled to camera device 10 via user interface 22.

One example of a software application is a camera application. CPU 16 executes the camera application, and in response, the camera application causes CPU 16 to generate content that display 28 outputs. In some examples, GPU 18 may be configured to process the content generated by CPU 16 for rendering on display 28. For instance, display 28 may output information such as light intensity, whether flash is enabled, and other such information. The user of camera device 10 may interface with display 28 to configure the manner in which the images are generated (e.g., with or without flash, focus settings, exposure settings, and other parameters).

As one example, after executing the camera application, camera device 10 may be considered to be in preview mode. In preview mode, camera 12 outputs image content to image signal processor 14 that performs camera processing and outputs image content to system memory 30 that display interface 26 retrieves and outputs on display 28. In preview mode, the user, via display 28, can view the image content that will be captured when the user engages a button (real or on display) to take a picture. As another example, rather than taking a still image (e.g., picture), the user may record video content (e.g., a series of images). During the recording, the user may be able to view the image content being captured on display 28.

In this disclosure, a preview image may be referred to as an image that is generated in preview mode. For instance, in preview mode, the image that camera 12 outputs and stores (e.g., in local memory 20 or system memory 30) for processing by image signal processor 14 or the image that image signal processor 14 generates and stores (e.g., in local memory 20 or system memory 30) may be referred to as a preview image. In general, a preview image may be an image generated in preview mode prior to capture and long-term storage of the image.

During preview mode or recording, camera device 10 (e.g., via CPU 16) may control the way in which camera 12 captures images (e.g., before capture or storing of image). CPU 16 in combination with image signal processor 14, GPU 18, a DSP, a vector processor, and/or display interface 26 may be configured to perform the example techniques described in this disclosure. For example, one or more processors may be configured to perform the example techniques described in this disclosure. Examples of the one or more processors include image signal processor 14, CPU 16, GPU 18, display interface 26, a DSP, a vector processor, or any combination of one or more of image signal processor 14, CPU 16, GPU 18, display interface 26, the DSP, or the vector processor.

CPU 16 may be configured to control the exposure and/or focus to capture visually pleasing images. For example, CPU 16 may be configured to generate signals that control the exposure, focus, and white balance, as a few non-limiting examples, of camera 12. CPU 16 may be configured to control the exposure, focus, and white balance based on the preview images received from image signal processor 14 during preview mode or recording. In this way, for still images, when the user engages to take the picture, the exposure, focus, and white balance are adjusted (e.g., the parameters for exposure, focus, and possibly white balance are determined before image capture so that the exposure, focus, and white balance can be corrected during the image capture). For recording, the exposure, focus, and white balance may be updated regularly during the recording.

As will be explained in more detail below, this disclosure describes techniques for encoding information that indicates which pixels in an image sensor are defective pixels. Due to the manufacturing tolerances of image sensors, some pixel locations can contain different types of fabrication defects. These defects include contamination from environmental particles present during the semiconductor fabrication process, electrical defects due to local non-uniformity in any of the deposited layers comprising the sensor, optical defects in the micro-lens and others. Any of these manufacturing issues can cause improper functioning of individual pixels on the sensor die. If the density and number of defective pixels on the sensor is small relative to the total number of pixels, the sensor can be used in an imaging system. Since most imaging sensors inevitably have some defects, many commercial image processing systems take great effort to identify and correct the defective pixels to improve the overall image quality.

Defective pixels can be handled within the image sensor (e.g., an image sensor of camera 12) or in digital image signal processor (ISP), such as image signal processor 14. An initial step in handling defective pixels is the detection or identification of the defective pixels. Then, the defective pixels may be corrected with data from neighboring pixels, e.g., using a defective pixel correction process.

Imaging sensor manufacturers can identify the location of each defective pixel by testing sensor function after completion of the fabrication process prior to product shipping. The defect locations are typically unique for each sensor die. Since the defect distribution is expected to remain static for the sensor lifetime, the defect location information can be stored in a static memory, such as flash, directly on the sensor die.

Defective pixel correction can also be performed on the sensor die during image acquisition, prior to image data output. Defective pixel correction on the sensor involves dedicated correction circuitry that leverages the static defect location information to compensate for the defective pixels with neighboring pixel data. The digital defective pixel correction circuitry can represent a significant overhead for a device, with a limited digital image processing capability, primarily designed to convert analog incident light intensity levels into a digital representation.

Since not all imaging sensors provide defective pixel correction, defective pixel detection and correction techniques have been independently developed for ISPs. Without a priori defective pixel location information, ISPs incur significant costs in terms of memory and computing circuitry to identify possible defective pixels and correct them within the received image data. In addition, since ISP resources are often shared among several image sensor streams, the defective pixel detection and correction is a continuously running process for every received frame, incurring power as well. Finally, while ISP algorithms have been developed to categorize well known “hot” or “cold” pixels, other types of defects are more difficult to isolate in the image stream, such as “stuck” pixels. In general, a “hot” pixel is a pixel that outputs a very high value for light intensity relative to the light actually received by that pixel, a “cold” pixel is a pixel that outputs a very low value for light intensity relative to the light actually received by that pixel, and a “stuck” pixel outputs a constant, and typically incorrect, light intensity value relative to the light actually received by that pixel.

Some techniques to optimize defective pixel identification and correction use a hybrid approach that leverages the defective pixel location information from the sensor manufacturer and the image pixel correction capabilities of an ISP. The challenge in this optimization lies in the efficient transfer of the defect location data from the sensor to the ISP and the utilization of this data within the ISP.

There are several possible methods of transmitting defect location data that identifies the defective pixels from the image sensor to the ISP with different tradeoffs for each one. For example, a one-time transmission of a location table may seem efficient from a bandwidth perspective, but requires significant memory resources at the ISP. Different data compression methods can be utilized to reduce the memory footprint of the location table, but, in spite of such techniques, the memory requirements remain significant and difficult to scale with larger sensor resolutions or higher defect densities. In other examples, repeatedly fetching small segments of the defect location table into an on-chip cache from a shared memory resource, such as DRAM, based on the instantaneous image processing kernel position, is cheaper and more scalable, but requires complex control circuitry and significant memory bandwidth and power.

In view of these drawbacks, this disclosure describes techniques that may improve the efficiency of identifying defective pixels and their ultimate correction using defective pixel correction techniques. In particular, this disclosure describes techniques for the encoding of defect information directly into the pixel data. The encoding techniques presented herein can be achieved with low overhead in power, bandwidth, and memory requirements with minimal to no loss in image quality.

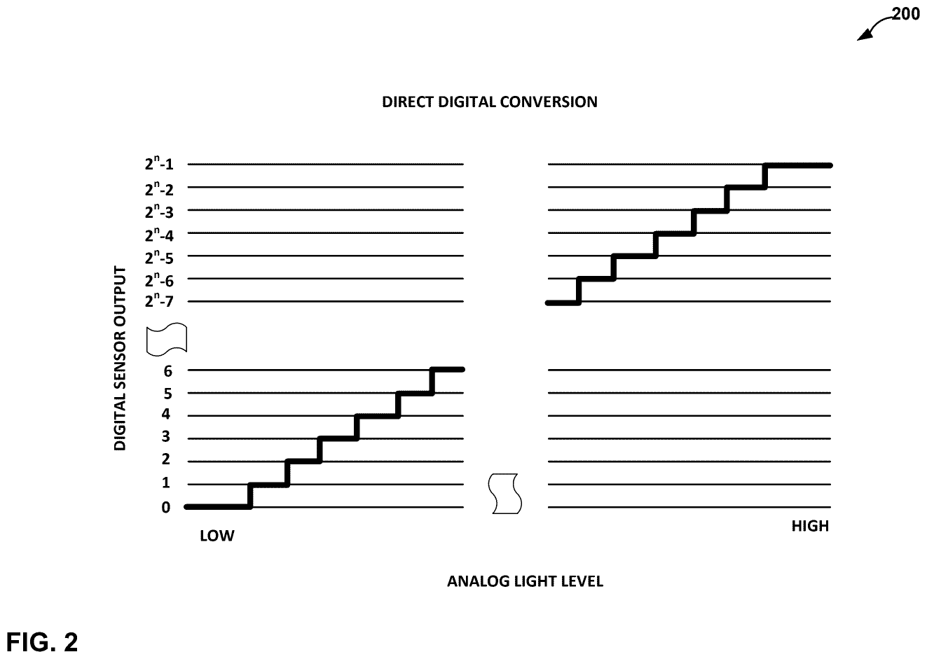

FIG. 2 is a conceptual diagram illustrating one example of direct digital conversion of an image sensor output. In particular, FIG. 2 shows an example of a scheme 200 for conversion of an analog light level measure of the incident light upon the pixel surface of an image sensor to a binary representation of an n-bit sensor digital sensor output. With n bits of digital representation, there are 2ⁿ possible levels. The lowest light level is encoded as a 0. The highest light intensity level encoded as 2ⁿ−1. Each digital value represents an analog light level between the two extremes in the range [0:2ⁿ−1].

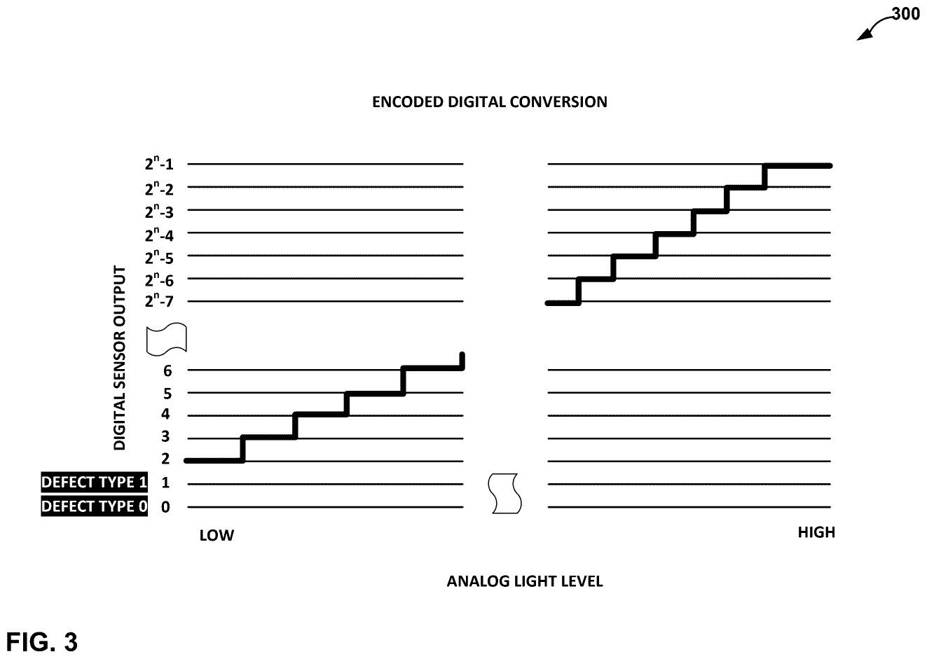

FIG. 3 is a conceptual diagram illustrating one example of an encoded digital conversion of an image sensor output in order to identify defective pixels. In particular, FIG. 3 shows an example of a conversion scheme 300 that incorporates additional information encoding. In FIG. 3, two digital output levels are reserved to carry defect information of each pixel. In this example, level 0 is reserved to designate a pixel defect of type 0 and level 1 is reserved to designate a different pixel defect type, pixel defect type 1. For example, defect type 0 may be used to indicate an isolated single pixel defect, while defect type 1 is reserved to designate a defective pixel that is part of a cluster of defects. Of course, any type of defect may be indicated.

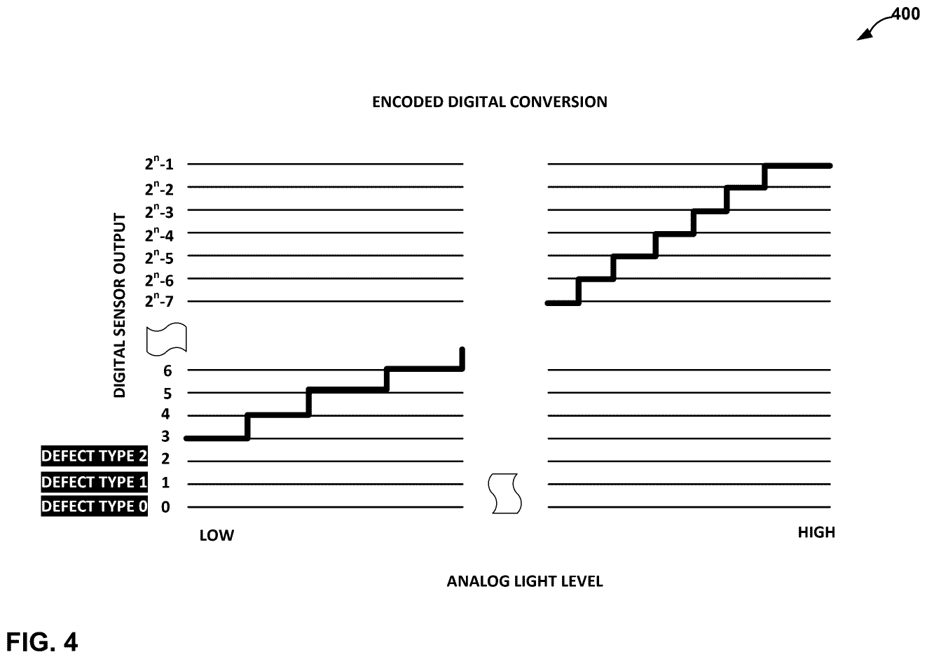

FIG. 4 is a conceptual diagram illustrating another example of an encoded digital conversion of an image sensor output in order to identify defective pixels. In particular, FIG. 4 shows an example of a conversion scheme 400 that incorporates additional information encoding for three pixel defect types. In FIG. 4, three digital output levels are reserved to carry defect information of each pixel. In this example, level 0 is reserved to designate a pixel defect of type 0, level 1 is reserved to designate a different, pixel defect type 1, and level 2 is reserved to designate yet another different pixel defect type 2. For example, defect type 2 may be used to indicate a patterned pixel defect type, wherein the particular pixel is part of a patterned defect (e.g., checkerboard or other pattern) across a portion of the image sensor. Since pixels with different defect types can be corrected in different ways using one of a plurality of defective pixel correction processes, the pixel data may be encoded to indicate the defect types separately. While FIGS. 3 and 4 show examples of indicating two or three defect types, respectively, the techniques of this disclosure may be applicable for use with indicating a single defect type or more than three defect types.

In the examples of FIGS. 3 and 4, the lowest two or three digital values are reserved, the lowest light intensity is represented by a value of 2 or 3, respectively, instead of 0. In other examples, other digital values can be reserved for representing defects, such as 2ⁿ−1 and 2ⁿ−2, for example. The benefit of using lower digital levels like 0 and 1 is that these levels do not depend on number of bits n used. As such, the encoding can remain constant across different sensor types and sensor output widths.

Sensor manufacturers may elect to use alternative encoding schemes to designate defect types. For example, encoding level 0, or “n zero bits” can correspond to defect type 0 and encoding level 2ⁿ−1, or “n one bits”, can correspond to a different defect type, defect type 1. As an example, if n equals 10, the value of 0 (e.g., 10 zero bits) may indicate defect type 0, and the value of 1023 (e.g., 10 one bits) may indicate defect type 1. Stated another way, the one or more digital values may include a value of 0 and a value of 2ⁿ−1 in the range from 0 to 2ⁿ−1. The value of 0 may indicate the first type of defective pixel, and the value 2ⁿ−1 may indicate the second type of defective pixel.

The above describes one example in which the one or more digital values may include a value of 0 and a value of 1, where the value of 0 indicates the first type of defective pixel, and the value of 1 indicates the second type of defective pixel. The above also describes another example in which the one or more digital values may include a value of 0 and a value of 2ⁿ−1, where the value of 0 indicates the first type of defective pixel, and the value 2ⁿ−1 indicates the second type of defective pixel. However, the techniques are not so limited. In general, the one or more digital values used to indicate a type of defective pixel may be one, two, three, or more digital values, and may be anywhere within the range of 0 to 2ⁿ−1, and all of the remaining values in the range of 0 to 2ⁿ−1 may be available for indicating a light intensity value.

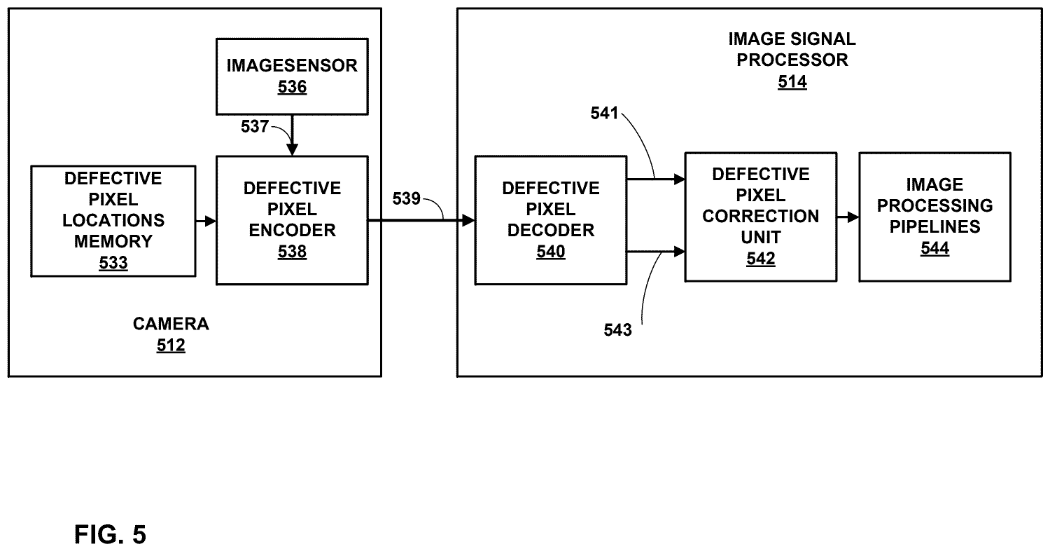

FIG. 5 is a block diagram illustrating an example of camera 512 and image signal processor 514, which are possible examples of camera 12 and image signal processor 14 of FIG. 1. As illustrated in FIG. 5, camera 512 includes image sensor 536, defective pixel locations memory 533, and defective pixel encoder 538. Image signal processor 514 includes defective pixel decoder 540, defective pixel correction unit 542, and image processing pipelines 544.

Image sensor 536 may be configured to capture pixel data 537 at each of a plurality of pixels of the image sensor. Pixel data 537 may be represented by an original digital value in a range from 0 to 2ⁿ−1, wherein the original digital value indicates a light intensity value, and n is the number of bits used to represent the digital value. As one example, pixel data 537 may be represented as shown in FIG. 2

Camera 512 may further include defective pixel locations memory 533. Defective pixel locations memory 533 may be a static memory, such as flash, and may include information that indicates which of the pixels of image sensor 536 are defective. Defective pixel locations memory 533 may further store information indicating a defect type (e.g., single pixel defect, cluster pixel defect, pattern pixel defect, hot pixel, cold pixel, stuck pixel etc.) for each of the defective pixels. That is, the location data in memory 533 identifies one or more pixels in the pixel data as being defective pixels.

Defective pixel encoder 538 may receive the defective pixel locations (and pixel defect types) from defective pixel locations memory 533 and encode pixel data 537 to generate encoded pixel data 539 that identifies the defective pixels. For example, defective pixel encoder 538 may use an encoding scheme as described above with reference to FIG. 3 and FIG. 4. In general, defective pixel encoder 538 may be configured to encode the pixel data to form encoded pixel data 539 that identifies the defective pixels, wherein one or more digital values (e.g., 0, 1, 2, etc.) of encoded pixel data 539 in the range from 0 to 2ⁿ−1 indicate a type of defective pixel. The remaining values (e.g., values greater than 1, 2, etc.) of the encoded pixel data in the range from 0 to 2ⁿ−1 indicate a light intensity value for the pixel.

In one example, one or more digital values in encoded pixel data 539 include a value 0 and a value 1 in the range from 0 to 2ⁿ−1, wherein the value of 0 indicates a first type of defective pixel, and wherein the value 1 indicates a second type of defective pixel.

In one example, the first type of defective pixel is a single defect, and the second type of defective pixel is a cluster defect. In another example, one or more digital values in encoded pixel data 539 include three or more value in the range from 0 to 2ⁿ−1, wherein the three or more values indicate three or more different types of defective pixels.

Defective pixel encoder 538 may then send encoded pixel data 539 to image signal processor 514. Defective pixel decoder 540 of image signal processor 514 may receive the encoded pixel data. Defective pixel decode 540 may determine whether a particular pixel in encoded pixel data 539 is defective based on the digital value of the particular pixel. For example, a value of 0 or 1 may indicate a defective pixel. Defective pixel decoder 540 may output decoded pixel data 541 that represents the light intensity values of the pixels back at the original range of 0 to 2ⁿ−1. Defective pixel decoder 540 may also output indications 543 that indicate the location and type of bad pixels in the image.

Defective pixel correction unit 542 may then perform a defective pixel correction process on pixel data 541 based on indications 543. That is, defective pixel correction unit 542 may perform a defective pixel correction process on the particular pixel based on the particular pixel being determined to be defective. In other examples, to the extent indications 543 include defective pixel types, defective pixel correction unit 542 may perform a defective pixel correction process on the particular pixel based on the particular pixel being determined to be defective, and further based on the type of defective pixel indicated by the encoded digital value for the particular pixel.

Defective pixel correction is an important process in digital imaging, used to correct defective or “bad” pixels on a sensor that can appear as dots of incorrect color or brightness in an image. One common approach involves filtering techniques, such as median filtering, where the value of a defective pixel is replaced with the median value of surrounding pixels. This method is effective because it uses the statistical distribution of the local area to maintain the overall texture and integrity of the image. Another method uses interpolation from neighboring pixels. Such an interpolation may involve calculating the convolution of adjacent pixels with an interpolation filter to estimate an interpolated value for the bad pixel. Interpolation can be particularly effective for isolated defective pixels in regions of uniform light intensity, where the neighboring pixels provide a reliable source of correction information. Both techniques aim to blend the corrected pixel into the surrounding image, improving the overall image quality without noticeable artifacts. In general, the defective pixel correction process of defective pixel correction unit 542 may include one or more of a median filtering process or interpolation processing using digital values of neighboring pixels to the particular pixel. After correcting for the defective pixels, defective pixel correction unit 542 may pass a corrected image to other image processing pipelines 544 for further processing. It should be noted that the defective pixel correction process need not happen immediately after identifying defective pixels using defective pixel decoder 540, but may happen later in any number of image processing pipelines 544.

In another example, rather than having defective pixel encoder 538 change the output light intensity values of defective pixels to a predetermined reserved value (e.g., 0 or 1 as in FIG. 3, or other values), image sensor 536 may be configured to directly output the reserved values for pixels determined to be defective by the manufacturer. That is, image sensor 536 may be configured such that the analog output of a defective pixel is tied directly to voltage level corresponding to a reserved value that indicates a defective pixel type. This may be accomplished by burning a fuse, for example, to output a specific constant value. For example, a voltage level of 0 can be accomplished by permanently connecting the pixel output to ground. The corresponding output of the analog-to-digital converter would be 0. Conversely, permanently connecting the pixel output to the voltage supply rail would result in an analog-to-digital output of 2ⁿ−1, represented in binary format by a sequence of 1's with a width n.

Defective pixel encoder 538 may still use the information in defective pixel locations memory 533 to determine which pixels are defective. However, rather than changing the output light intensity value for such defective pixels, defective pixel encoder 538 may simply allow the output digital values for such pixels to pass through, as image sensor 536 itself has already encoded such pixel values as being defective. Defective pixel encoder 538 may still encode the non-defective pixel values into the remaining range (e.g., 2 to 2ⁿ−1).

In FIG. 5, the defect location encoding scheme is contained entirely within the sensor image data (e.g., encoded pixel data 539) and does not require any additional data transmission bandwidth, since the pixel output bit width remains the same. Nor does this technique require any additional defect location information storage. The only informational cost to this defect encoding scheme is the loss of the reserved levels to carry light intensity information. This overhead can be quite small. For example, modem image sensors encode light intensity with at least n=10 bits, corresponding to 2ⁿ=1024 levels. Reserving two of these levels to convey defect state information represents only a 0.2% informational overhead. This overhead becomes even smaller for sensors with a larger dynamic range, or greater n.

While the example of FIG. 5 shows the defective pixel encoding being performed on camera 512 (e.g., on the sensor die), other examples of the disclosure may have the defective pixel encoding being performed on image signal processor 514 or on another circuit that is between camera 512 and image signal processor 514. In this example, the information in defective pixel locations memory 533 may be communicated to the defective pixel encoder a single time.

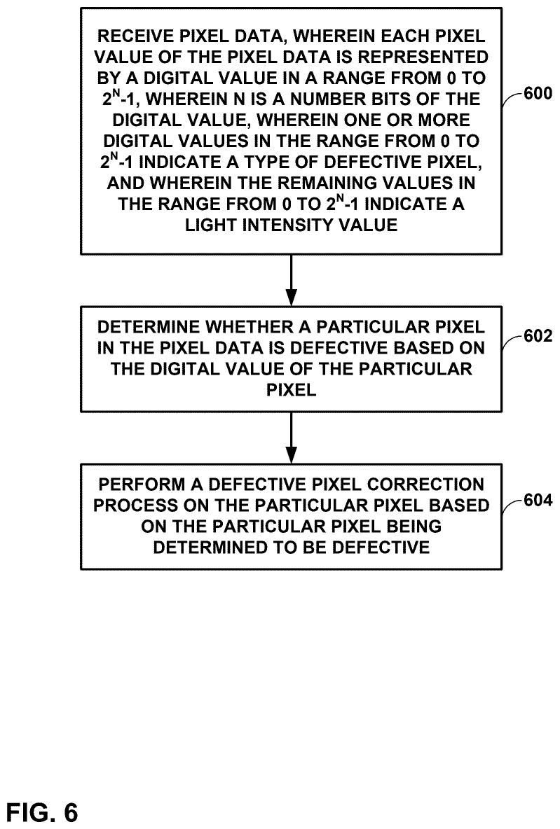

FIG. 6 is a flowchart illustrating one example process of the disclosure. The example of FIG. 6 is described with reference to one or more image signal processors, such as image signal processor 514.

At 600, image signal processor 514 may be configured to receive pixel data, wherein each pixel value of the pixel data is represented by a digital value in a range from 0 to 2ⁿ−1, wherein n is a number bits of the digital value, wherein one or more digital values in the range from 0 to 2ⁿ−1 indicate a type of defective pixel, and wherein remaining values in the range from 0 to 2ⁿ−1 indicate a light intensity value (e.g., for the pixel). In one example, the one or more digital values include a value 0 and a value 1 in the range from 0 to 2ⁿ−1, wherein the value of 0 indicates a first type of defective pixel, and wherein the value 1 indicates a second type of defective pixel. In another example, the one or more digital values include three or more values in the range from 0 to 2ⁿ−1, wherein the three or more values indicate three or more different types of defective pixels.

Image signal processor 514 may determine whether a particular pixel (e.g., in the pixel data) is defective based on the digital value of the particular pixel (602), and may perform a defective pixel correction process on the particular pixel based on the particular pixel being determined to be defective (604). To perform the defective pixel correction process, image signal processor 514 may be configured to perform the defective pixel correction process on the particular pixel based on the particular pixel being determined to be defective and further based on the type of defective pixel indicated by the digital value for the particular pixel. The defective pixel correction may include one or more of a median filtering process or interpolation processing using digital values of neighboring pixels to the particular pixel.

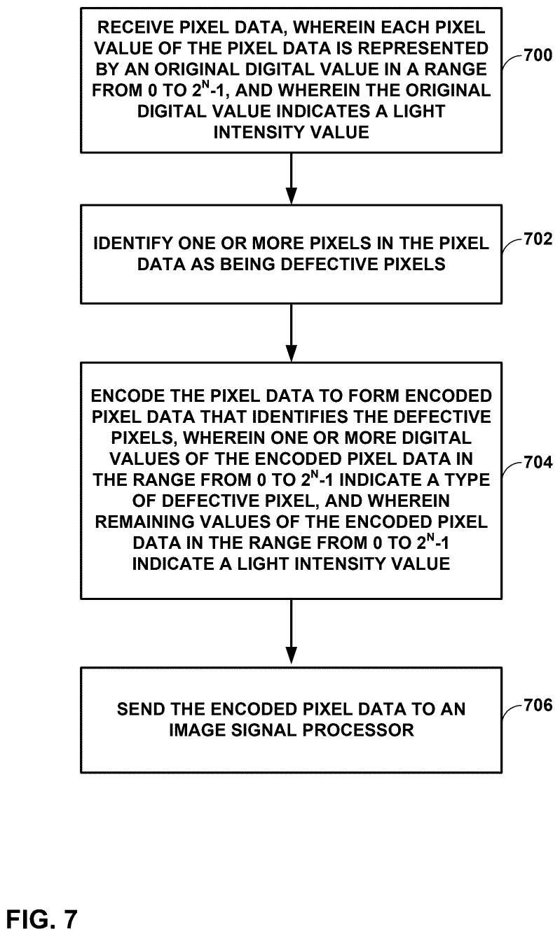

FIG. 7 is a flowchart illustrating another example process of the disclosure. The example of FIG. 7 is described with reference to a camera with an image sensor, such as camera 512 and image sensor 536.

Image sensor 536 may be configured to capture pixel data, wherein each pixel value of the pixel data is represented by an original digital value in a range from 0 to 2ⁿ−1, wherein the original digital value indicates a light intensity value. Processing circuitry, such as defective pixel encoder 538 may be configured to receive such pixel data (700). Defective pixel encoder 538 may identify one or more pixels in the pixel data as being defective pixels (702). In other examples, defective pixel encoder 538 may determine one or more pixels in the pixel data as being defective pixels from a defective pixel location map stored in memory. Defective pixel encoder 538 may further encode the pixel data to form encoded pixel data that identifies the defective pixels, wherein one or more digital values of the encoded pixel data in the range from 0 to 2ⁿ−1 indicate a type of defective pixel, and wherein remaining values of the encoded pixel data in the range from 0 to 2ⁿ−1 indicate a light intensity value (e.g., for the pixel) (704). Defective pixel encoder 538 may send the encoded pixel data to an image signal processor (706).

The following clauses describes one or more additional example aspects in accordance with this disclosure.

Aspect 1. An apparatus for processing pixel data from a sensor, the apparatus comprising: a memory configured to receive the pixel data; and one or more processors in communication with the memory, the one or more processors configured to: receive the pixel data, wherein each pixel value of the pixel data is represented by a digital value in a range from 0 to 2ⁿ−1, wherein n is a number bits of the digital value, wherein one or more digital values in the range from 0 to 2ⁿ−1 indicate a type of defective pixel, and wherein remaining values in the range from 0 to 2ⁿ−1 indicate a light intensity value for the pixel; determine whether a particular pixel is defective based on the digital value of the particular pixel; and perform a defective pixel correction process on the particular pixel based on the particular pixel being determined to be defective.

Aspect 2. The apparatus of Aspect 1, wherein one of: the one or more digital values include a value 0 and a value 1 in the range from 0 to 2ⁿ−1, wherein the value of 0 indicates a first type of defective pixel, and wherein the value 1 indicates a second type of defective pixel; or the one or more digital values include a value of 0 and a value of 2ⁿ−1 in the range from 0 to 2ⁿ−1, wherein the value of 0 indicates the first type of defective pixel, and wherein the value 2ⁿ−1 indicates the second type of defective pixel.

Aspect 3. The apparatus of Aspect 2, wherein the first type of defective pixel is a single defect, and wherein the second type of defective pixel is a cluster defect.

Aspect 4. The apparatus of Aspect 1, wherein the one or more digital values include three or more values in the range from 0 to 2ⁿ−1, wherein the three or more values indicate three or more different types of defective pixels.

Aspect 5. The apparatus of any of Aspects 1-4, where to perform the defective pixel correction process, the one or more processors are configured to: perform the defective pixel correction process on the particular pixel based on the particular pixel being determined to be defective and further based on the type of defective pixel indicated by the digital value for the particular pixel.

Aspect 6. The apparatus of any of Aspects 1-5, wherein the defective pixel correction process comprises one or more of a median filtering process or interpolation processing using digital values of neighboring pixels to the particular pixel.

Aspect 7. The apparatus of any of Aspects 1-6, wherein the one or more processors comprise an image signal processor, and wherein the apparatus further includes the sensor.

Aspect 8. A method of processing pixel data from a sensor, the method comprising: receiving pixel data, wherein each pixel value of the pixel data is represented by a digital value in a range from 0 to 2ⁿ−1, wherein n is a number bits of the digital value, wherein one or more digital values in the range from 0 to 2ⁿ−1 indicate a type of defective pixel, and wherein remaining values in the range from 0 to 2ⁿ−1 indicate a light intensity value; determining whether a particular pixel is defective based on the digital value of the particular pixel; and performing a defective pixel correction process on the particular pixel based on the particular pixel being determined to be defective.

Aspect 9. The method of Aspect 8, one of: the one or more digital values include a value 0 and a value 1 in the range from 0 to 2ⁿ−1, wherein the value of 0 indicates a first type of defective pixel, and wherein the value 1 indicates a second type of defective pixel; or the one or more digital values include a value of 0 and a value of 2ⁿ−1 in the range from 0 to 2ⁿ−1, wherein the value of 0 indicates the first type of defective pixel, and wherein the value 2ⁿ−1 indicates the second type of defective pixel.

Aspect 10. The method of Aspect 9, wherein the first type of defective pixel is a single defect, and wherein the second type of defective pixel is a cluster defect.

Aspect 11. The method of Aspect 8, wherein one or more digital values include three or more values in the range from 0 to 2ⁿ−1, wherein the three or more values indicate three or more different types of defective pixels.

Aspect 12. The method of any of Aspects 8-11, where performing the defective pixel correction process comprises: performing the defective pixel correction process on the particular pixel based on the particular pixel being determined to be defective and further based on the type of defective pixel indicated by the digital value for the particular pixel.

Aspect 13. The method of any of Aspects 8-12, wherein the defective pixel correction process comprises one or more of a median filtering process or interpolation processing using digital values of neighboring pixels to the particular pixel.

Aspect 14. An apparatus for processing pixel data, the apparatus comprising: a sensor configured to capture pixel data, wherein each pixel value of the pixel data is represented by an original digital value in a range from 0 to 2ⁿ−1, and wherein the original digital value indicates a light intensity value; and processing circuitry in communication with the sensor, the processing circuitry configured to: receive the pixel data; identify one or more pixels in the pixel data as being defective pixels; encode the pixel data to form encoded pixel data that identifies the defective pixels, wherein one or more digital values of the encoded pixel data in the range from 0 to 2ⁿ−1 indicate a type of defective pixel, and wherein remaining values of the encoded pixel data in the range from 0 to 2ⁿ−1 indicate a light intensity value; and send the encoded pixel data to an image signal processor.

Aspect 15. The apparatus of Aspect 14, wherein one of: the one or more digital values in the encoded pixel data include a value 0 and a value 1 in the range from 0 to 2ⁿ−1, wherein the value of 0 indicates a first type of defective pixel, and wherein the value 1 indicates a second type of defective pixel; or the one or more digital values in the encoded pixel data include a value 0 and a value 2ⁿ−1 in the range from 0 to 2ⁿ−1, wherein the value of 0 indicates the first type of defective pixel, and wherein the value 21-1 indicates the second type of defective pixel.

Aspect 16. The apparatus of Aspect 15, wherein the first type of defective pixel is a single defect, and wherein the second type of defective pixel is a cluster defect.

Aspect 17. The apparatus of Aspect 14, wherein the one or more digital values include three or more values in the range from 0 to 2ⁿ−1, wherein the three or more values indicate three or more different types of defective pixels.

Aspect 18. The apparatus of any of Aspects 14-17, wherein the apparatus further includes the image signal processor.

Aspect 19. The apparatus of Aspect 18, wherein the image signal processor is configured to: perform a defective pixel correction process on a particular pixel based on the particular pixel being determined to be defective based on the encoded pixel data.

Aspect 20. The apparatus of Aspect 19, wherein the defective pixel correction process comprises one or more of a median filtering process or interpolation processing using digital values of neighboring pixels to the particular pixel.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for processing pixel data from a sensor, the apparatus comprising:
a memory configured to receive the pixel data; and
one or more processors in communication with the memory, the one or more processors configured to:
receive the pixel data, wherein each pixel value of the pixel data is represented by a digital value in a range from 0 to 2ⁿ−1, wherein n is a number bits of the digital value, wherein one or more digital values in the range from 0 to 2ⁿ−1 indicate a type of defective pixel, and wherein remaining values in the range from 0 to 2ⁿ−1 indicate a light intensity value;
determine whether a particular pixel is defective based on the digital value of the particular pixel; and
perform a defective pixel correction process on the particular pixel based on the particular pixel being determined to be defective.

2. The apparatus of claim 1, wherein one of:
the one or more digital values include a value 0 and a value 1 in the range from 0 to 2ⁿ−1, wherein the value of 0 indicates a first type of defective pixel, and wherein the value 1 indicates a second type of defective pixel; or
the one or more digital values include a value of 0 and a value of 2ⁿ−1 in the range from 0 to 2ⁿ−1, wherein the value of 0 indicates the first type of defective pixel, and wherein the value 2ⁿ−1 indicates the second type of defective pixel.

3. The apparatus of claim 2, wherein the first type of defective pixel is a single defect, and wherein the second type of defective pixel is a cluster defect.

4. The apparatus of claim 1, wherein the one or more digital values include three or more values in the range from 0 to 2ⁿ−1, wherein the three or more values indicate three or more different types of defective pixels.

5. The apparatus of claim 1, where to perform the defective pixel correction process, the one or more processors are configured to:
perform the defective pixel correction process on the particular pixel based on the particular pixel being determined to be defective and further based on the type of defective pixel indicated by the digital value for the particular pixel.

6. The apparatus of claim 1, wherein the defective pixel correction process comprises one or more of a median filtering process or interpolation processing using digital values of neighboring pixels to the particular pixel.

7. The apparatus of claim 1, wherein the one or more processors comprise an image signal processor, and wherein the apparatus further includes the sensor.

8. A method of processing pixel data from a sensor, the method comprising:
receiving pixel data, wherein each pixel value of the pixel data is represented by a digital value in a range from 0 to 2ⁿ−1, wherein n is a number bits of the digital value, wherein one or more digital values in the range from 0 to 2ⁿ−1 indicate a type of defective pixel, and wherein remaining values in the range from 0 to 2ⁿ−1 indicate a light intensity value;
determining whether a particular pixel is defective based on the digital value of the particular pixel; and
performing a defective pixel correction process on the particular pixel based on the particular pixel being determined to be defective.

9. The method of claim 8, wherein one of:
the one or more digital values include a value 0 and a value 1 in the range from 0 to 2ⁿ−1, wherein the value of 0 indicates a first type of defective pixel, and wherein the value 1 indicates a second type of defective pixel; or
the one or more digital values include a value of 0 and a value of 2ⁿ−1 in the range from 0 to 2ⁿ−1, wherein the value of 0 indicates the first type of defective pixel, and wherein the value 2ⁿ−1 indicates the second type of defective pixel.

10. The method of claim 9, wherein the first type of defective pixel is a single defect, and wherein the second type of defective pixel is a cluster defect.

11. The method of claim 8, wherein the one or more digital values include three or more values in the range from 0 to 2ⁿ−1, wherein the three or more values indicate three or more different types of defective pixels.

12. The method of claim 8, where performing the defective pixel correction process comprises:
performing the defective pixel correction process on the particular pixel based on the particular pixel being determined to be defective and further based on the type of defective pixel indicated by the digital value for the particular pixel.

13. The method of claim 8, wherein the defective pixel correction process comprises one or more of a medial filtering process or interpolation processing using digital values of neighboring pixels to the particular pixel.

14. An apparatus for processing pixel data, the apparatus comprising:
a sensor configured to capture pixel data, wherein each pixel value of the pixel data is represented by an original digital value in a range from 0 to 2ⁿ−1, and wherein the original digital value indicates a light intensity value; and
processing circuitry in communication with the sensor, the processing circuitry configured to:
receive the pixel data;
identify one or more pixels in the pixel data as being defective pixels;
encode the pixel data to form encoded pixel data that identifies the defective pixels, wherein one or more digital values of the encoded pixel data in the range from 0 to 2ⁿ−1 indicate a type of defective pixel, and wherein remaining values of the encoded pixel data in the range from 0 to 2ⁿ−1 indicate a light intensity value; and
send the encoded pixel data to an image signal processor.

15. The apparatus of claim 14, wherein one of:
the one or more digital values in the encoded pixel data include a value 0 and a value 1 in the range from 0 to 2ⁿ−1, wherein the value of 0 indicates a first type of defective pixel, and wherein the value 1 indicates a second type of defective pixel; or
the one or more digital values in the encoded pixel data include a value 0 and a value 2ⁿ−1 in the range from 0 to 2ⁿ−1, wherein the value of 0 indicates the first type of defective pixel, and wherein the value 2ⁿ−1 indicates the second type of defective pixel.

16. The apparatus of claim 15, wherein the first type of defective pixel is a single defect, and wherein the second type of defective pixel is a cluster defect.

17. The apparatus of claim 14, wherein the one or more digital values include three or more values in the range from 0 to 2ⁿ−1, wherein the three or more values indicate three or more different types of defective pixels.

18. The apparatus of claim 14, wherein the apparatus further includes the image signal processor.

19. The apparatus of claim 18, wherein the image signal processor is configured to:
perform a defective pixel correction process on a particular pixel based on the particular pixel being determined to be defective based on the encoded pixel data.

20. The apparatus of claim 19, wherein the defective pixel correction process comprises one or more of a median filtering process or interpolation processing using digital values of neighboring pixels to the particular pixel.
